(19) United States
(12) Patent Application Publication
(10) Pub. No.: US 2012/0163946 A1
(43) Pub. Date: Jun. 28, 2012

(54) FLEXIBLE MATERIAL HANDLING, STORAGE AND RETRIEVAL APPARATUS AND METHODS

(75) Inventors: Robert HOFFMAN, Marysville, MI (US); Christian WURLL, Newnan, GA (US)

(73) Assignee: Kuka Systems Corporation North America, Sterling Heights, MI (US)

(21) Appl. No.: 13/306,409

(22) Filed: Nov. 29, 2011

Related U.S. Application Data
(60) Provisional application No. 61/459,959, filed on Dec. 22, 2010.

(51) Int. Cl. B65G 1/137

(52) U.S. Cl. 414/298; 414/808

(57) ABSTRACT

A case handling apparatus receives cases on a conveyor, picks cases therefrom and stores them, via a robot, in a bookcase storage system. The robot retrieves cases from storage and drops them on a discharge conveyor. Alternately, the robot does not pick cases, which then transfer or pass directly through respective pick-point and drop-point stations to discharge. Preferably cases are introduced and discharged from the apparatus on a single conveyor whether picked or passed through. A variety of bookcase storage systems are disclosed as are related and other methods.

### RELATED APPLICATION

Applicant claims priority of U.S. provisional patent application Ser. No. 61/459,959 filed Dec. 22, 2010. That application is incorporated herein by express reference.

### FIELD OF THE INVENTION

This invention relates to material or article handling and more particularly to the transfer of articles in an incoming stream through a storage area and into a discharge stream.

### BACKGROUND OF THE INVENTION

In article storage and retrieval, it is known to receive articles in an incoming stream of articles, to store them, to selectively retrieve them and to discharge them. Typically articles on an incoming conveyor will be diverted into a storage system where they are stored. Thereafter, the articles may be selectively retrieved and discharged for order picking, article grouping, downstream packaging, distribution, manufacture or the like. In this context, the articles may comprise individual items, cases or pallets of items or other articles of a wider variety of configurations or groupings.

Such systems are typically controlled by a programmable controller for diverting incoming articles to particular storage locations and thereafter for article retrieval and discharge for downstream handling.

Mechanisms typically used in such systems include conveyors, mechanical diverters and transfer mechanisms, storage racks or conveyors and the like. While robots have been used in such transfers, even current systems with robots lack newly desired performance functions and do not fully provide the desired combination of the following goals and objectives.

While such prior mechanisms or systems have provided certain functions, the desire to improve such systems arises from several desirable goals not previously attained in combination. Such goals include simplified cost-effective sorting, flexibility to provide a variety of substantially differing throughput and configuration requirements, adaptability to limited spatial parameters, accommodation to current article pick procedures of customers and adaptability to automatic layer descrambling (for grouped or combined article groupings).

Accordingly, it has been an objective of the invention to provide apparatus and methods producing this combination of goals or controllable to produce selected combinations of these goals.

### SUMMARY OF THE INVENTION

In summary, a preferred embodiment of the invention includes a conveyor system having input and discharge functions separated operationally by article pick-point and drop-point stations, a robot having end-of-arm tooling (“EOAT”) for picking, transferring, retrieving and dropping a wide variety of intended article configurations, and a “bookcase” type or configured storage facility for receiving articles picked off from the conveyor system by the robot, storing the articles and holding the articles for further engagement by the robot and transport to the drop-off station. The conveyor system may include one or more conveyors, if more, preferably aligned end-to-end at the respective pick-off and drop-off stations. The bookcase storage system may be in a vertical plane above or below the conveyor system or laterally spaced therefrom, and a robot is operationally disposed so as to have access to the pick-off station, the drop-station and the bookcase storage system therebetween.

In operation, incoming articles are handled in one of two modes. In one mode, a selected incoming article is engaged by the EOAT of the robot at the pick-off station and transported to a dedicated position in the bookcase storage system. Thereafter, the robot is controlled to re-engage the stored article in the bookcase storage system and transport it to the drop-off station where it is placed for discharge transfer on the conveyor system. In another mode of operation, the “pass-through” mode, the incoming article is recognized to be responsive to an immediate discharge demand. It is conveyed directly through the pick-off station and the drop-off station to the discharge stream without diversion to the bookcase storage system. It is thus not engaged by the robot for storage or otherwise (unless the robot is used to transfer the articles directly from the incoming to the discharge streams).

It will be appreciated that a variety of robot, conveyor and bookcase storage systems can be used to accomplish the goals and objects of the invention.

### BRIEF DESCRIPTION OF THE DRAWINGS

FIGS. 1-3 are respectively plan, elevational and end views of one embodiment of the invention;

FIG. 4 is an illustrative elevational view of the embodiment of FIG. 1, but omitting the bookcase storage unit for clarity;

FIG. 5 is an illustrative elevational view of a bookcase storage unit as used in the embodiments of FIGS. 1-4;

FIGS. 6-8 are respective plan, elevational and end view of a first alternate embodiment of the invention (FIG. 7 omitting the robots for clarity);

FIG. 9 is a plan view of a second alternate embodiment of the invention;

FIG. 10 is a plan view of a third alternate embodiment of the invention;

FIG. 11 is an end view of a fourth alternate embodiment of the invention; and

FIG. 12 is an end view of a fifth alternate embodiment of the invention.

### FURTHER DESCRIPTION OF THE INVENTION AND EMBODIMENTS

In this description, it will be appreciated that a “bookcase storage apparatus” includes one or preferably more “bookshelf” units each having a plurality of storage slots sized for receiving a variety of articles or cases to be handled. Preferably, the articles or cases are centered in the respective slots when delivered there by the robot(s).

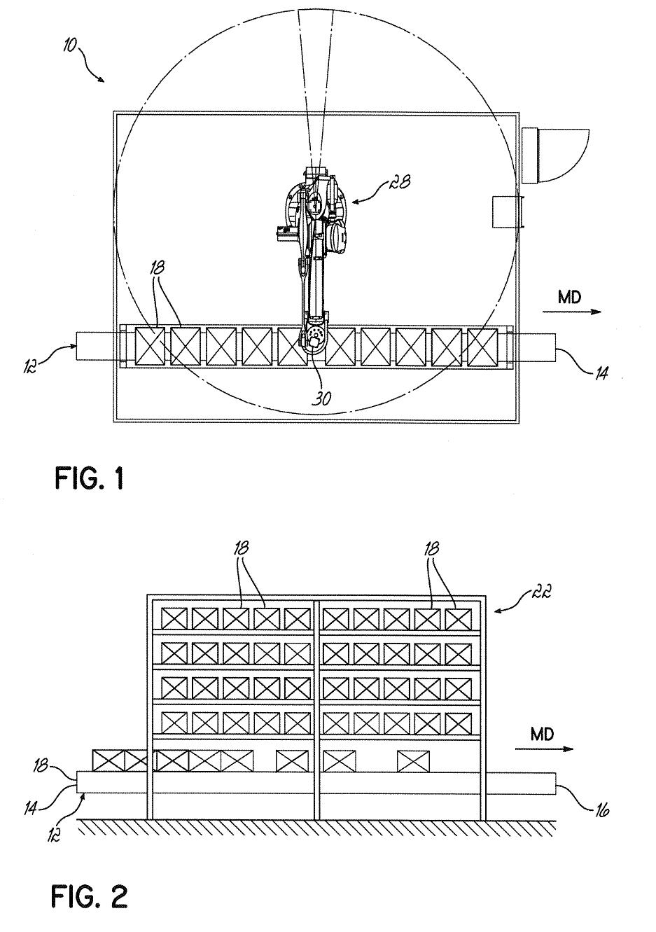

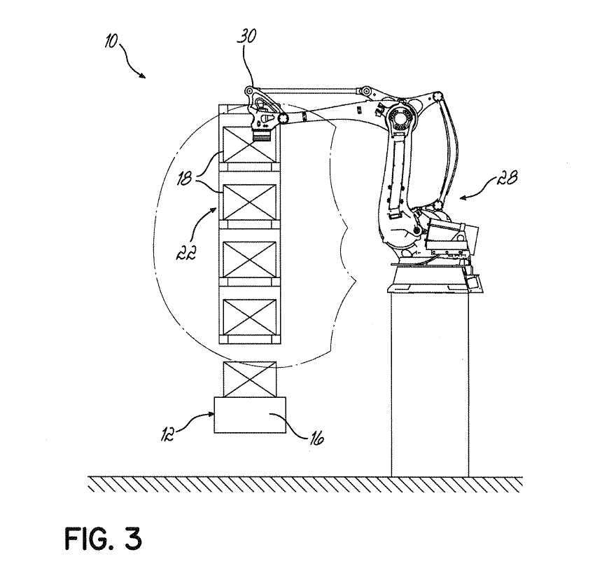

One preferred embodiment of the invention is shown in FIGS. 1-5. This embodiment of the invention comprises a robotic sorter cell 10 capable of sorting more than 200 cases per hour (CPH) assuming that every incoming case has to be initially stored and then retrieved at a later time. A conveyor system 12 comprises an incoming section 14 which allows direct pass-through to the exit or discharge accumulation section 16 if a case string matches the sorter output demanded by a control system. In applications where the SKU proliferation of the pallet or article configuration is low, the CPH throughput will increase with this approach to the conveyors since not every incoming case has to be stored and retrieved.

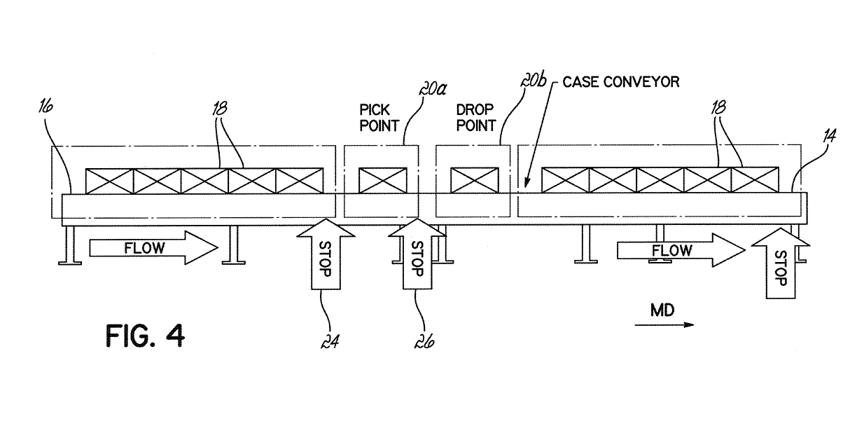

The source cases or articles 18 (those terms are used interchangeably herein unless otherwise stated) are presented to the robot/storage by conveyor 12 (if not passed through directly to discharge 16). The conveyor system preferably provides the multiple zones 14, 16 allowing accumulation before the pick-point 20a (FIG. 4), a drop-point 20b and accumulation and/or discharge after the drop point 20b.

In this embodiment, the bookcase storage unit 22 is disposed above the incoming/outgoing conveyor sections 14, 16, or in any other suitable position.

The cases 18 will be located at the pick-point position in the direction of the flow by a drop stop 24. This drop stop 24 can be powered by, but not limited to, pneumatics, electrical cylinder or solenoid device. The case 18 will be justified to one side of the conveyor 14 for pick up.

On case retrieval from the bookcase storage unit 22, the robot will place the cases 18 in the drop-point station 20b on the center of the conveyor 16. There are no drop stops or crowders required for this location, but an optional drop stop 26 may be provided.

The sections 14, 16 of any suitable conveyor type can be provided with a drop stop, gap pulling and back pressure or on a zoned conveyor. This will be determined by systems case specifications.

The conveyor sections 14, 16 (which may comprise a single conveyor) of this embodiment provide a case rate of 600 CPH minimum. This may be required for certain commercial applications, even though a single robot cell 10 is capable of a lower throughput as stated above.

The case sequence on the conveyors 14, 16 will be tracked and monitored with a counting program. This is done to identify the case 18 that is arriving at the pick-point 20a. If this case 18 already matches the next case requirement, that case will pass directly through. The matching can be based on a unique case identifier (e.g. case specific barcode or RFID tag) or based on a common classification (e.g. same package type but different flavor) This option may be disabled in circumstances where exact case sequence, even within the SKU population, is required. In these circumstances the case stream will be 100% sorted.

As the case 18 reaches the pick-point 20a the robot 28 will, in one mode, pick and sort the case into the “bookshelf case” storage 22. Any suitable warehouse management system (WMS) system will provide to the robot cell 10 SKU information that includes but is not limited to: SKU identification, case dimensions and case weight. Based on the SKU identification the robot 28 will scan a data base for the required gripping parameters and retrieve the case 18 from the pick-point station 20a.

The robot gripper or end-of-arm tooling (EOAT) 30 (FIG. 3) may be a servo-driven end of arm tool (MAT) with centering capabilities. This will guarantee that the case is where it needs to be even with variables in pick location and size. This will also help in placing multiple case sizes in the bookshelf storage slots. The cases preferably will always be centered no matter what the size in the bookshelf apparatus.

Once the robot 28 has picked the case, it will be told by a suitable controller what slot to store the case in the bookcase storage unit 22. This will be calculated by a sortation program within the control system for the robot cell 10. The program will maintain a FIFO (first in first out) data base of the cases 18 and their locations. In applications where low SKU volume is present with high case flow, the program can also guarantee FIFO requirements with in a SKU population if required.

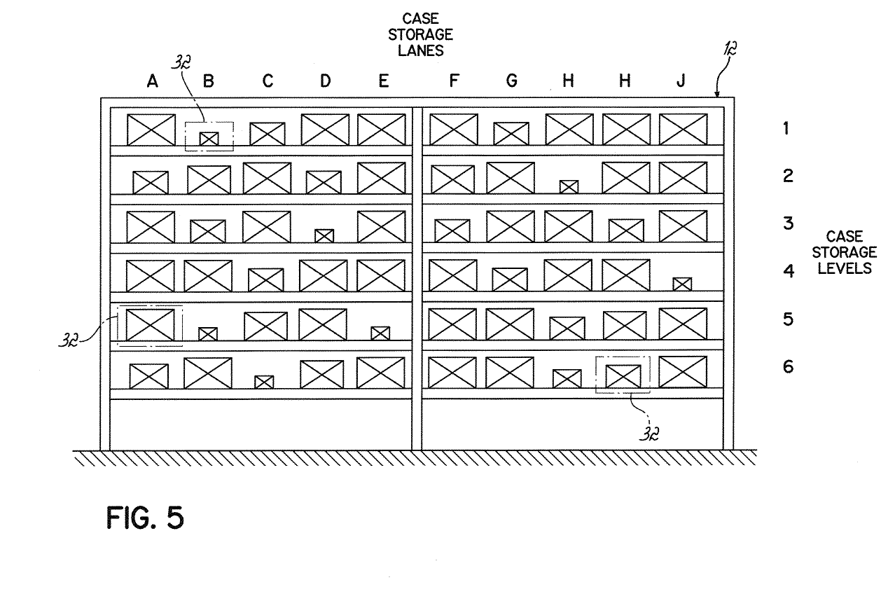

The bookcase apparatus 22 will be sized to meet the requirements driven by case size and weight of the application. This cell 10 can be sized to handle items e.g. as small as a pack of gum to as large as a refrigerator. Excessive size can reduce the CPH throughput but also reduced case 18 sizes can increase the throughput. The bookcase storage apparatus 22 will have multiple storage slots (illustrated at 32 in FIG. 5 and further indicated by the cases 18 therein) and all case sizes will be stored in the center location of these slots independent of the case dimensions.

After the robot 28 has placed the inbound case 18 within the bookcase storage unit 22 it will tell the control program that it has completed its task. If the bookcase storage unit 22 contains a case 18 to satisfy the outbound case sequence the control program will tell the robot 28 what storage slot to retrieve the next case 18 from, as required for the output case sequence. With this command the robot 28 will receive the SKU information in the same manner as the inbound case. The robot 28 will retrieve the EOAT 30 parameters from the data base, retrieve the case from the bookcase storage slot and place it on the drop-point 20b of the conveyor system 12.

As the cases 18 are placed on the drop-point 20b, they will advance to the outbound or discharge accumulation area 16 in the required sequence. If a case or cases 18 are allowed to advance to the outbound accumulation area 16 in pass-through mode, the robot 28 will wait for a clear signal before advancing to the drop point.

In a second mode of operation of this embodiment, the incoming cases 18 are simply passed through the pick-point 20a and drop-point 20b directly to discharge 16 without intervening storage. Overall output is thus enhanced.

For illustration, a bookcase apparatus 22 is shown in FIG. 5 with a plurality of case storage lanes and case storage levels as shown.

### Alternate Embodiment

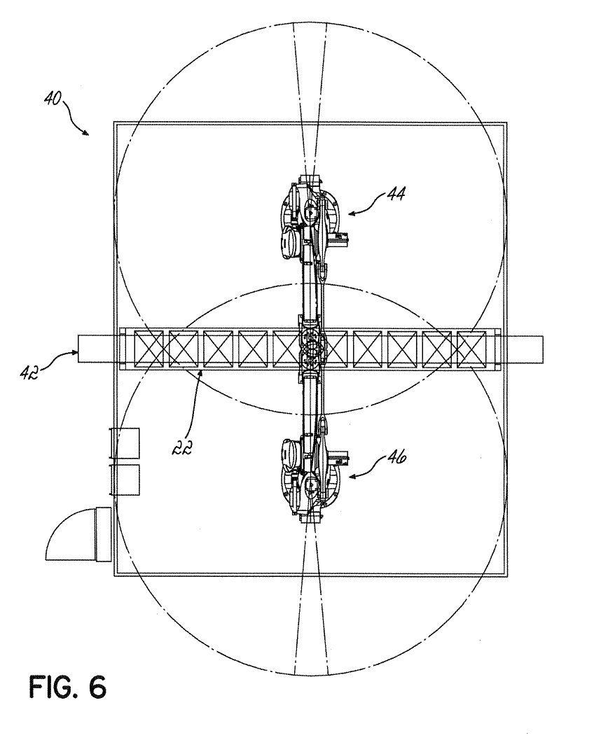

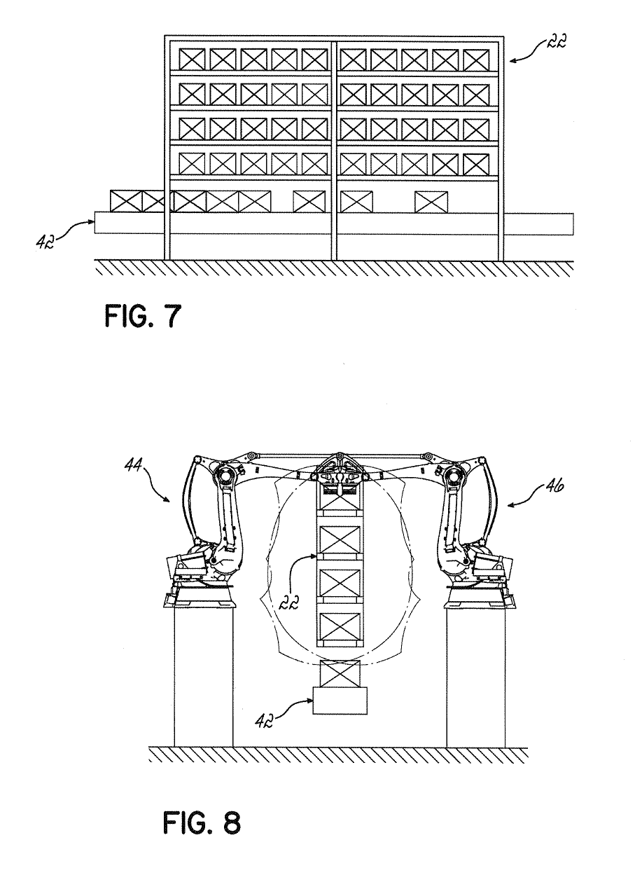

The alternate embodiment of the invention shown in FIGS. 6-8 comprises a robotic sorter cell 40 capable of producing more than 400 CPH assuming 100% case sortation. The conveyor system 42 defines incoming and discharge sections similar to those of system 12 of the first embodiment, and provides a case rate of 600 CPH minimum. This is required for certain commercial applications even though a dual robot cell is capable of less CPH as stated above.

In this embodiment, two robots 44, 46 function the same way as the single robot 28 in the preceding embodiment. The difference will be that the robots can be assigned respective duties based on one of two methods:
Dedicated Source to Storage Robots or Storage to Target Robots.
Each robot is preferably capable of Source to Storage and Storage to Target with duties assigned on a first available basis.

Here, again, a bookcase storage unit 22 is oriented above the incoming/outgoing conveyor system 42. The two robots 44, 46 are disposed, one on each side of the conveyor 42 and the bookcase storage unit 22. A single or further conveyor system (not shown) could be located above the bookcase storage unit.

### Second Alternate Embodiment

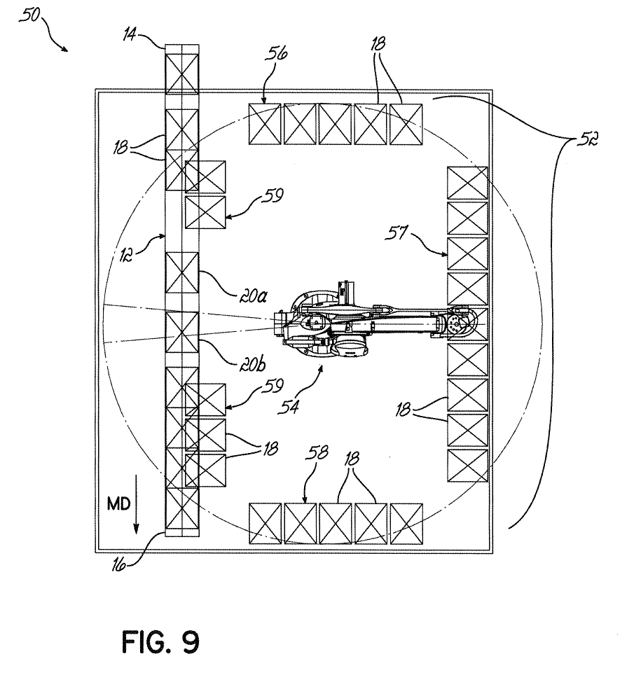

This embodiment of the invention is shown in FIG. 9 and comprises a version of a robotic sorter cell 50 producing more than 200 CPH assuming 100% case sortation. Except as noted below, this operation is similar to that of the above embodiment.

The conveyor system provides a case rate of 600 CPH minimum. This is required for certain commercial applications even though a dual robot cell is capable of less CPH as stated above.

A bookcase storage unit 52 is U-shaped or rectangularly-shaped as shown and surrounds the robot 54 in linear sections 56, 57, 58, 59 allowing more storage capacity. This creates a larger buffer between the upstream process and the output case stream. This functionality is especially effective in locations that prefer a “Wave” pick system. In this embodiment, a conveyor system 12 with inbound and discharge stream sections 14, 16 is provided for cases 18, while it will be appreciated robot 54 can move 360° to serve each section 56-59 of the bookcase storage unit.

### Third Alternate Embodiment

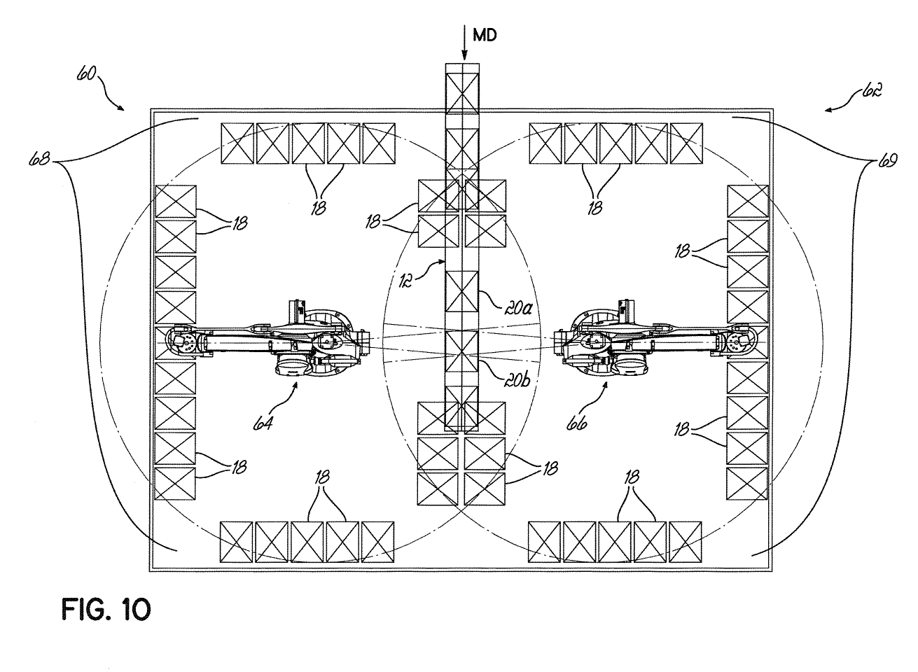

This embodiment of the invention is shown in FIG. 10 and comprises a robotic sorter cell producing more than 400 CPH, assuming 100% case sortation. This concept works the same as the above second embodiment except as noted below.

Here there are two sorter cells 60, 62 and two respective robots 64, 66 working off a conveyor system 12.

The conveyors provide a case rate of 600 CPH minimum. This is required for certain commercial applications even though a dual robot cell is capable of less CPH as stated above.

The two robots 64, 66 in this system 60, 62 function the same way as the single robot cell 50 of the above embodiment, but are juxtaposed adjacent one another on opposite sides of conveyor system 12. Use of the second robot or cell increases the throughput of the system. The control program will additionally be equipped with a load balancing mechanism to ensure that both robots 64, 66 and the multiple sectioned U-shaped bookcase storage systems 68, 69 are equally utilized to ensure a high performance.

### Fourth Alternate Embodiment

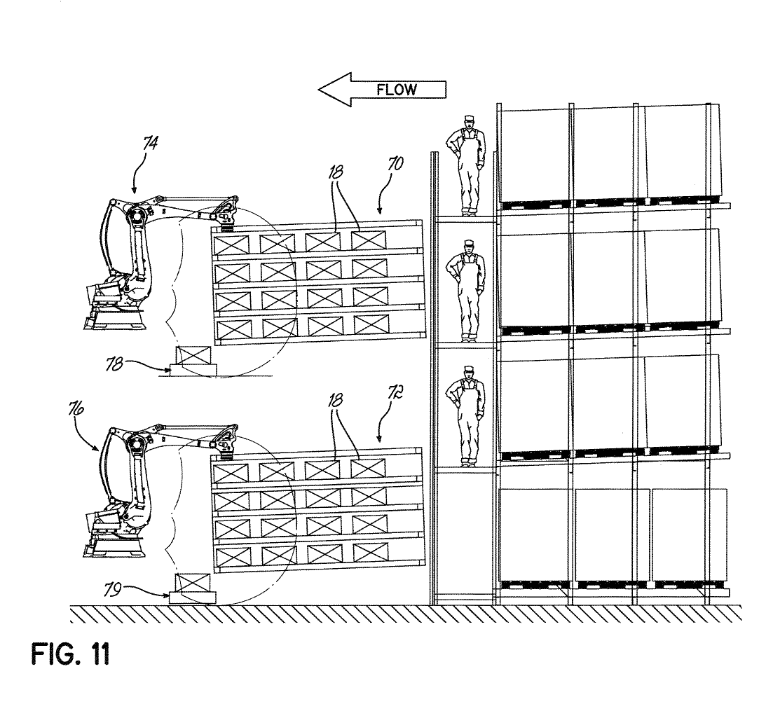

This embodiment of the invention shown in FIG. 11 illustrates the option of manually loading cases (from the right-hand or source supply side) to different source conveyor systems 70, 72 in center disposition of the system and the robot sorters 74, 76 pick the cases 18 from the source conveyors and place them on the respective discharge conveyors 78, 79 in the required sequence. The reach of the robots 74, 76 can be extended by mounting the robots 74, 76 onto linear slides extended in a machine direction.

In this case, the robots 74, 76 do not “pick” incoming articles or cases 18. These are manually (or by other means) loaded into a double (or single) article feeding source conveyor 70, 72 as illustrated. Preferably, two robots 74, 76 pick selected cases from this storage and transfer them to discharge or output conveyors.

This embodiment does not include the “pass-through” operational feature of the prior embodiments.

### Fifth Alternate Embodiment

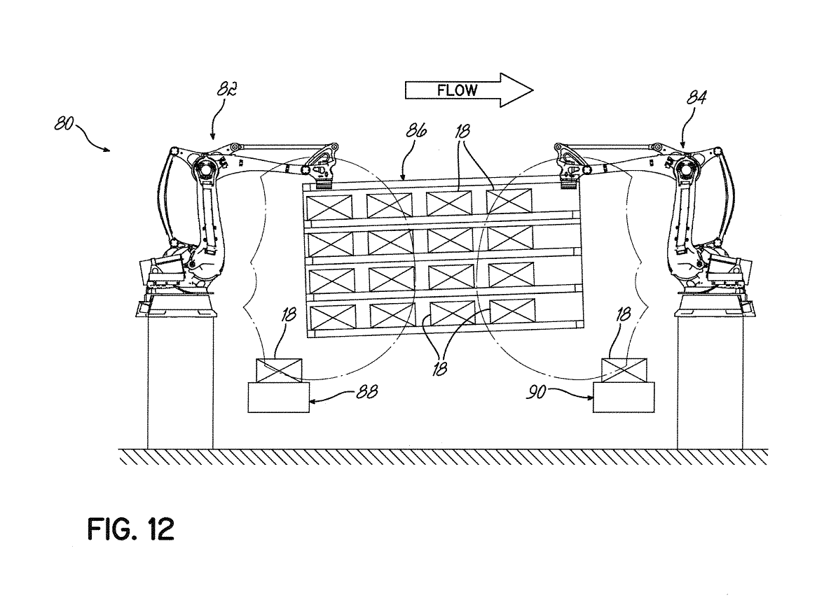

This embodiment, shown in FIG. 12, illustrates a sorter cell 80 providing the option of robotically loading SKU'S to a source conveyor.

Here the robot 82 on one side loads the storage lanes 86 from an incoming conveyor 88 while the robot 84 on the other side picks the cases 18 from a lane 86 and drops them onto a discharge conveyor 90, for example. Here again, this configuration of this embodiment provides no direct “pass-through”operation as described above embodiments. This infeed to robot 82 from conveyor 88 may come from an automatic layer descrambler.

It will be appreciated that this embodiment may be modified by allowing a pass-through of cases on conveyor 88 directly to a discharge, thus incorporating a dual function through the input station represented by conveyor 88 and robot 82 and a further function by using robot 82 to pick and store cases from conveyor 88 into storage 86 for selection and discharge by robot 84 and discharge conveyor 90.

As noted above, a variety of conveyor, bookcase storage systems and robots can be used to accomplish the goals and objectives of the invention. These are to include, but not be limited to, the foregoing embodiments and further include conveyors in arraignments of single and/or multiple units with one or more pick and place points each, bookcase storage units that can be either static or mobile in nature that can be accessed from single or multiple sides and robots in configurations that may require single or multiple robots that interact with a variety of configurations of conveyors and bookshelf storage systems previously described.

What is claimed is:

1. A case handling apparatus comprising:
at least one case conveyor system having a case pick-point and a case drop-point;
at least one robot;
a bookcase storage unit for cases;
said robot being controllable in one mode to pick cases from said pick-point, to place cases in said bookcase storage unit for storage, to retrieve cases from said storage unit and to drop retrieved cases to said drop-point, and in another mode to allow passage of cases on said conveyor system directly through said pick-point and said drop-point without transfer by said robot to said bookcase storage unit.

2. Apparatus as in claim 1 wherein said bookcase storage unit is disposed in a plane over said case conveyor system.

3. Apparatus as in claim 1 wherein said pick-point and said drop-point are defined in a single conveyor.

4. Apparatus as in claim 1 further including at least two robots, one disposed on each side of said bookcase storage unit.

5. Apparatus as in claim 1 wherein said bookcase storage unit is a first storage unit comprising at least four storage sides, said robot disposed between respective ones of said sides.

6. Apparatus as in claim 5 wherein one of said sides of said bookcase storage units is disposed above said case conveyor system.

7. Apparatus as in claim 5 further including a second bookcase storage unit comprising at least four sides and a second robot operatively associated therewith, said second bookcase storage unit oriented on an opposite side of said case conveyor system from said first storage unit.

8. A case handling apparatus comprising:
a supply source of cases;
a plurality of case storage lanes in a first set of storage lanes;
at least one robot;
a discharge conveyor;
said robot operable for transferring cases from said lanes to said conveyor; and
wherein cases are manually loaded into said lanes.

9. Apparatus as in claim 8 including two sets of storage lanes;
a second robot;
a second discharge conveyor;
each robot operably disposed for transferring a case from respective set of storage lanes to a respective discharge conveyor.

10. A case handling apparatus comprising:
a first robot;
a first conveyor for feeding cases to a position proximate said first robot;
a plurality of case storage lanes;
a second robot;
a second conveyor for discharging cases from said apparatus;
said first robot operable to pick cases from said first conveyor and transfer picked cases to a case storage lane;
said second robot operable to retrieve cases from said storage lanes and drop retrieved cases onto said second conveyor.

11. Apparatus as in claim 10 wherein said first robot is further operable to pass cases on said first conveyor for direct discharge thereon from said apparatus.

12. A method of handling respective cases in storage and in pass-through modes and comprising the steps of:
introducing cases on an infeed conveyor to a pick-point;
picking selected cases from said conveyor at said pick-point with a robot and delivering cases from the robot to a bookcase storage unit;
retrieving picked cases from said bookcase storage unit with said robot and placing cases on a discharge conveyor at a drop point; and
selectively passing cases through said pick-point and said drop-point without picking cases and delivering them to said bookcase storage unit.

13. A method as in claim 12 including infeeding and discharging cases on a single conveyor.
